(19) United States
(12) Patent Application Publication
(10) Pub. No.: US 2012/0007859 A1
(43) Pub. Date: Jan. 12, 2012

(54) METHOD AND APPARATUS FOR GENERATING FACE ANIMATION IN COMPUTER SYSTEM

(75) Inventors: Shin-Jun Lee, Yongin-si (KR); Dae-Kyu Shin, Suwon-si (KR); Kwang-Cheol Choi, Gwacheon-si (KR); Sang-Youn Lee, Seoul (KR); Dae-Hyun Pak, Iksan-si (KR); Jin-Kyu Hwang, Bucheon-si (KR)

(73) Assignees: INDUSTRY-ACADEMIC COOPERATION FOUNDATION, YONSEI UNIVERSITY, Seoul (KR); SAMSUNG ELECTRONICS CO., LTD., Suwon-si (KR)

(21) Appl. No.: 13/177,038

(22) Filed: Jul. 6, 2011

(30) Foreign Application Priority Data
Jul. 9, 2010 (KR) 10-2010-0066080

(51) Int. Cl. G06T 13/40; G06T 13/80

(52) U.S. Cl. 345/419; 345/473

(57) ABSTRACT

A method and apparatus generate a face animation in a computer system. An input of a face image is received. A head model and a skull model are determined for the face image. The head model is matched with the skull model, and a face model is generated. At least one parameter for the generated face model is adjusted according to an expression of the input face image, thus being capable of allowing a user to easily generate a face model and a facial animation with various expressions without manually adjusting various parameters.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Jul. 9, 2010 and assigned Serial No. 10-2010-0066080, the contents of which are herein incorporated by reference.

### TECHNICAL FIELD OF THE INVENTION

The present invention relates to a method and apparatus for generating a face animation in a computer system. More particularly, the present invention relates to a method and apparatus for matching an estimated skull shape with a standard head model and generating an anatomic face model, and automatically estimating parameters for the face model and generating an animation of the face model in a computer system.

### BACKGROUND OF THE INVENTION

Due to the recent development of a computer graphic technology, an avatar technology of replacing a user in a virtual reality such as an animation, a movie, a game and the like is being developed. For example, the conventional art uses an avatar with a talk or talking action instead of a real user in an Internet chat or a personal homepage, as well as a videoconference, a game, and an electronic commercial transaction.

The conventional avatar technology has used an avatar that is unrelated to a user's actual appearance. But, recent research is being made for a technology for providing an avatar reflecting a user's appearance. Particularly, most active research is being made for face modeling and expression animation for an avatar such that they can most accurately represent a person's appearance.

Generally, a human face is composed of a number of muscles and delicate skin tissues, so it is needed to delicately adjust face muscles and skin tissues so as to make various expressions. The conventional facial animation technologies use a method of manually adjusting a parameter of a face muscle or inputting a position and range stiffness of the face muscle. However, this method has a disadvantage in that a user has to onerously input parameters for the expression manually, and has a further disadvantage in that it is difficult and/or time-consuming for a non-skilled user to obtain a face model with a high-precision expression.

### SUMMARY OF THE INVENTION

An aspect of the present invention is to substantially solve at least the above problems and/or disadvantages and to provide at least the advantages below. Accordingly, one aspect of the present invention is to provide a method and apparatus for generating a facial animation in a computer system.

Another aspect of the present invention is to provide a method and apparatus for automatically estimating parameters for a face model and generating an anatomic facial animation in a computer system.

Another aspect of the present invention is to provide a method and apparatus for expressing, by three-dimensional points, an object face, and matching the object face with a standard head model in a computer system.

Another aspect of the present invention is to provide a method and apparatus for, according to a position relationship for facial features of an object face, selecting a skull model for face model generation and matching the skull model with a standard head model in a computer system.

Another aspect of the present invention is to provide a method and apparatus for generating a face model considering age and sex in a computer system.

Another aspect of the present invention is to provide a method and apparatus for automatically setting positions and parameters of a muscle and spring node for a face model based on an image of an object face in a computer system.

Yet another aspect of the present invention is to provide a method and apparatus for, according to an expression of an object face, adjusting parameters of a muscle and spring node for a face model and generating a facial animation in a computer system.

The above aspects are achieved by providing a method and apparatus for generating a facial animation in a computer system.

According to one aspect of the present invention, a method for generating a facial animation in a computer system is provided. An input of a face image is received. A head model and a skull model are determined for the face image. The head model is matched with the skull model, and a face model is generated. At least one parameter for the generated face model is adjusted according to an expression of the input face image.

According to another aspect of the present invention, an apparatus for generating a facial animation in a computer system is provided. The apparatus includes a user interface, a face model set unit, and a face model adjustment unit. The user interface receives an input of a face image. The face model set unit determines a head model and a skull model for the face image, matches the head model with the skull model, and generates a face model. The face model adjustment unit adjusts at least one parameter for the generated face model according to an expression of the input face image.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a computer system that supports face animation according to an embodiment of the present invention;

FIG. 2 is a block diagram of a face model set unit in a computer system according to an embodiment of the present invention;

FIG. 3 is a diagram illustrating a process for generating a face model in a computer system according to an embodiment of the present invention; and

FIG. 4 illustrates a process for generating a face model and generating an animation of the face model in a computer system according to an embodiment of the present invention.

### DETAILED DESCRIPTION OF THE INVENTION

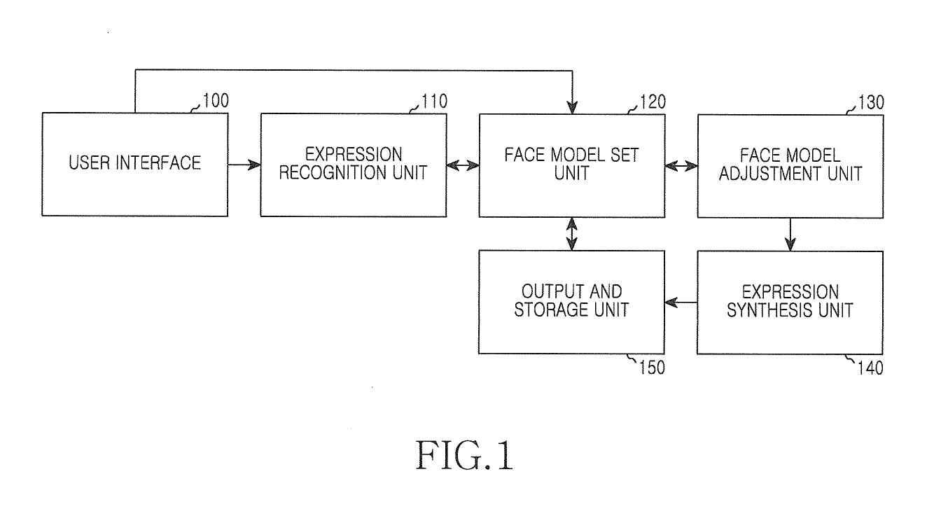

FIGS. 1 to 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Preferred embodiments of the present invention will be described with reference to the accompanying drawings. In the following description, well-known functions or constructions are not described in detail as they would obscure the invention in unnecessary detail. And, terms described below, which are defined considering functions in the present invention, can be different depending on the user and operator's intention or practice. Therefore, the terms should be defined on the basis of the disclosure throughout this specification.

Embodiments of the present invention provide a method and apparatus for matching a skull shape with a standard head model and generating an anatomic face model, and automatically estimating parameters for the face model and generating an animation of the face model in a computer system. In the following description, the computer system refers to all electronic devices that apply a computer graphic technology, and includes all of a portable terminal, a mobile communication terminal, a Personal Computer (PC), a notebook computer, and so forth.

FIG. 1 illustrates a computer system that supports face animation according to the present invention.

Referring to FIG. 1, the computer system includes a user interface 100, an expression recognition unit 110, a face model set unit 120, a face model adjustment unit 130, an expression synthesis unit 140, and an output and storage unit 150.

The user interface 100 receives, from a user, an input of various data for generating a face model and generating an animation of the generated face model. In detail, the user interface 100 receives an input of a face image from a camera (not shown) and provides the face image to the expression recognition unit 110 and the face model set unit 120. The user interface 100 also receives an input of age and sex from the user through a keypad (not shown) or a touch sensor (not shown) and provides the age and sex to the face model set unit 120. Here, for the purpose of face model generation, the user interface 100 may first receive an input of an expressionless face image and, afterward, receive an input of face images of various expressions. Furthermore, for the purpose of face model generation, the user interface 100 may receive an input of face images photographed at different angles, from one or more cameras (not shown).

The expression recognition unit 110 recognizes an expression of a face image provided from the user interface 100. The expression recognition unit 110 may also use expression recognition algorithms widely known in the art. The expression recognition unit 110 extracts a feature of each expression from an expression database (DB) 122 included in the face model set unit 120 and learns the feature of each expression, thereby being able to classify whether the input face image is an image corresponding to an expression by means of the feature of the input face image. For example, the expression recognition unit 110 may compare the feature of the input face image with the expression DB 122 and classify whether the expression of the input face image is a non expression, a smiling expression, a crying expression, or an angry expression. When the expression of the face image is classified, the expression recognition unit 110 provides the face image, and feature and expression classification information of the face image to the face model set unit 120. When the face image is an expressionless image, the expression recognition unit 110 analyzes a position relationship for facial features of the expressionless face image, and then provides the analysis result to the face model set unit 120.

The face model set unit 120 stores information for generating a face model for an object face based on an age, sex, and a face image input from the user interface 100, and generating an animation of the generated face model. In detail, the face model set unit 120 acquires a three-dimensional point model representing a face based on the face image, fits a standard head model previously made through a statistic method to the three-dimensional point model, matches the fitted standard head model with a skull corresponding to a position relationship for facial features of the input face image, and generates a basic face model corresponding to the face image. Here, the face model set unit 120 sets a skin thickness map for the basic face model, generates a skin for the basic face model, disposes a muscle and a spring node, sets initial parameters of the disposed muscle and spring node for the basic face model, and generates a face model for the face image.

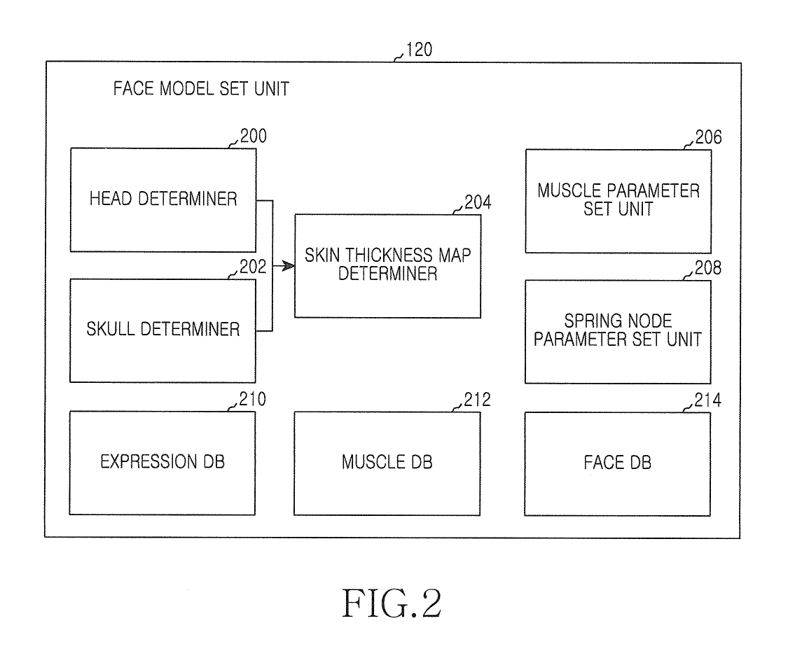

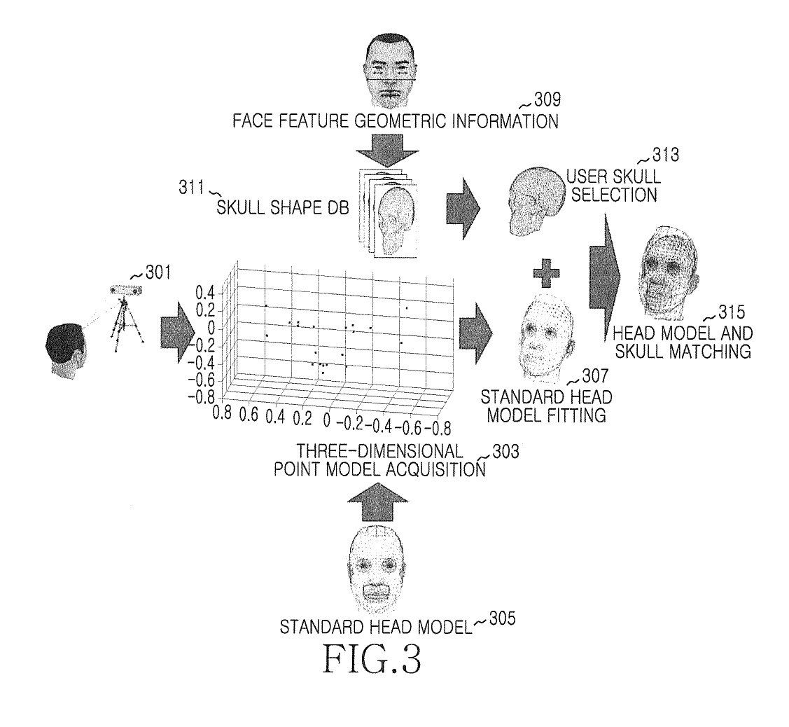

A detailed operation of the face model set unit 120 is described below on the basis of FIGS. 2 and 3 below.

FIG. 2 illustrates a face model set unit in a computer system according to an embodiment of the present invention, and FIG. 3 is a diagram of a process for generating a face model in a computer system according to an embodiment of the present invention.

Referring to FIG. 2, the face model set unit 120 includes a head determiner 200, a skull determiner 202, a skin thickness map determiner 204, a muscle parameter set unit 206, a spring node parameter set unit 208, an expression DB 210, a muscle DB 212, and a face DB 214.

The face model set unit 120 acquires (303) a three-dimensional point model representing facial features of a user's face by three-dimensional points, from a plurality of face images 301 provided from the user interface 100. The face model set unit 120 fits (307) a standard head model 305 previously made through a statistic method to the three-dimensional point model. When the standard head model 305 previously made through the statistic method is one or more in number, the face model set unit 120 may select one standard head model through the head determiner 200. For example, the head determiner 200 may select a standard head model according to sex or age of a user.

Furthermore, the face model set unit 120 receives geometric information 309 representing a feature of a face image (i.e., position relationship information 309 on facial features of the face image) from the expression recognition unit 110, and selects (313) a skull shape corresponding to position relationship for the facial features in a skull shape DB 311 through the skull determiner 202. That is, the present invention includes the skull shape DB 311 that includes previously analyzed skull shapes dependent on position relationship information on facial features of a face image and previously stored skull shapes by position relationship for the facial features of the face image. Here, the skull shapes may be distinguished according to sex of an object face. As such, the skull determiner 202 may select the skull shape considering the sex of the object face in addition to the position relationship for the facial features of the face image.

The face model set unit 120 then matches (315) the selected skull shape with the standard head model fitted to the three-dimensional point model and generates a face model. At this time, the face model set unit 120 disposes muscles between the skull shape and the fitted standard head model, with reference to the muscle DB 212. Furthermore, the face model set unit 120 sets a skin thickness map for the skull shape and the fitted standard head model through the skin thickness map determiner 204, and generates a skin for the generated face model.

The face model set unit 120 sets a position and length of a muscle, a position and elasticity of a spring node for the generated face model by means of the muscle parameter set unit 206 and the spring node parameter set unit 208. Here, the spring node may be set in a mesh structure form for the generated face model, or may be set in a mesh structure of a different shape according to sex of an object. The elasticity of the spring node represents a skin elasticity of the face model, and may be set according to age of a user who is an object of the face model.

The face model set unit 120 includes the muscle DB 212 that stores a graph of skin elasticity dependent on muscle contractility per age and structural information on an expression model. Accordingly, the face model set unit 120 may set a position and elasticity of a spring node for the generated face model, with reference to the muscle DB 212.

Furthermore, the face model set unit 120 includes the expression DB 210 for storing and managing feature and expression classification information of a face image input from the expression recognition unit 110, and a muscle parameter value and a spring node parameter value for each expression. That is, the expression DB 210 may include values representing a position and length of a muscle and an elasticity of a spring node for each expression. The values representing the position and length of the muscle and the elasticity of the spring node for the each expression may be acquired from the face model adjustment unit 130. Additionally, the face model set unit 120 includes the face DB 214 for storing and managing generated face models.

After the face model is generated as above, when a face image of an expression other than a non expression is input from the expression recognition unit 110, the face model set unit 120 provides the face image of the other expression and the generated face model to the face model adjustment unit 130.

The face model adjustment unit 130 performs a function for, if a face model and a face image representing a specific expression are provided from the face model set unit 120, adjusting an expression of the face model to the specific expression. In detail, the face model adjustment unit 130 repeatedly adjusts parameters of a muscle and spring node for the face model such that the expression of the face model is consistent with the specific expression. For example, the face model adjustment unit 130 adjusts a position and length of the muscle of the face model, a length of the spring node and such, compares an expression of the adjusted face model with the specific expression, determines whether the expression of the adjusted face model is consistent with the specific expression, and when not consistent, readjusts a position and length of the muscle of the adjusted face model, a length of the spring node, and such, and repeatedly performs the readjustment operation until the expression of the face model is consistent with the specific expression. According to an embodiment, the face model adjustment unit 130 may adjust the parameter of the spring node for the face model with reference to the graph of skin elasticity according to muscle contractility from the muscle DB 212. Furthermore, when the face model adjustment unit 130 controls a position or length of a muscle, a phenomenon of abnormally contracting a skin in a direction of movement of the muscle may occur. Considering this, the face model adjustment unit 130 may perform a function of performing compensation such that a skin of a range influenced by the controlled muscle is not contracted. That is, the face model adjustment unit 130 may control parameters of spring nodes within the range influenced by the controlled muscle, preventing the occurrence of the phenomenon of abnormal skin contraction.

If the expression of the face model is consistent with the specific expression, the face model adjustment unit 130 stores parameter values of a muscle and spring node for the face model in the expression DB 210 of the face model set unit 120. When parameter values for the same expression have been previously stored in the expression DB 210, the face model adjustment unit 130 may store the average of a currently acquired parameter value and the previously stored parameter value in the expression DB 210. This is for future use when generating expressions not defined in the computer system.

The face model adjustment unit 130 outputs and provides the expression-adjusted face model to the output and storage unit 150 through the expression synthesis unit 140.

If an event for generating a new expression occurs through the user interface 100, the expression synthesis unit 140 performs a function for receiving parameter values of a muscle and spring node per expression from the face model set unit 120 through the face model adjustment unit 130 and, through this, generates a new expression for the face model. For example, if an event for generating an animation that varies from a non expression to a smiling expression occurs, the expression synthesis unit 140 performs a function for generating expressions between the non expression and the smiling expression. These expressions may be generated by gradually adjusting parameter values of a muscle and spring node for the face model close to parameter values of a muscle and spring node for the smiling expression from parameter values of a muscle and spring node for the non expression. The expression synthesis unit 140 provides the face model provided from the face model adjustment unit 130 and the face model with the new expression, to the output and storage unit 150.

The output and storage unit 150 controls and processes a function for displaying, on a screen, the face model provided from the expression synthesis unit 140, and storing information on the face model.

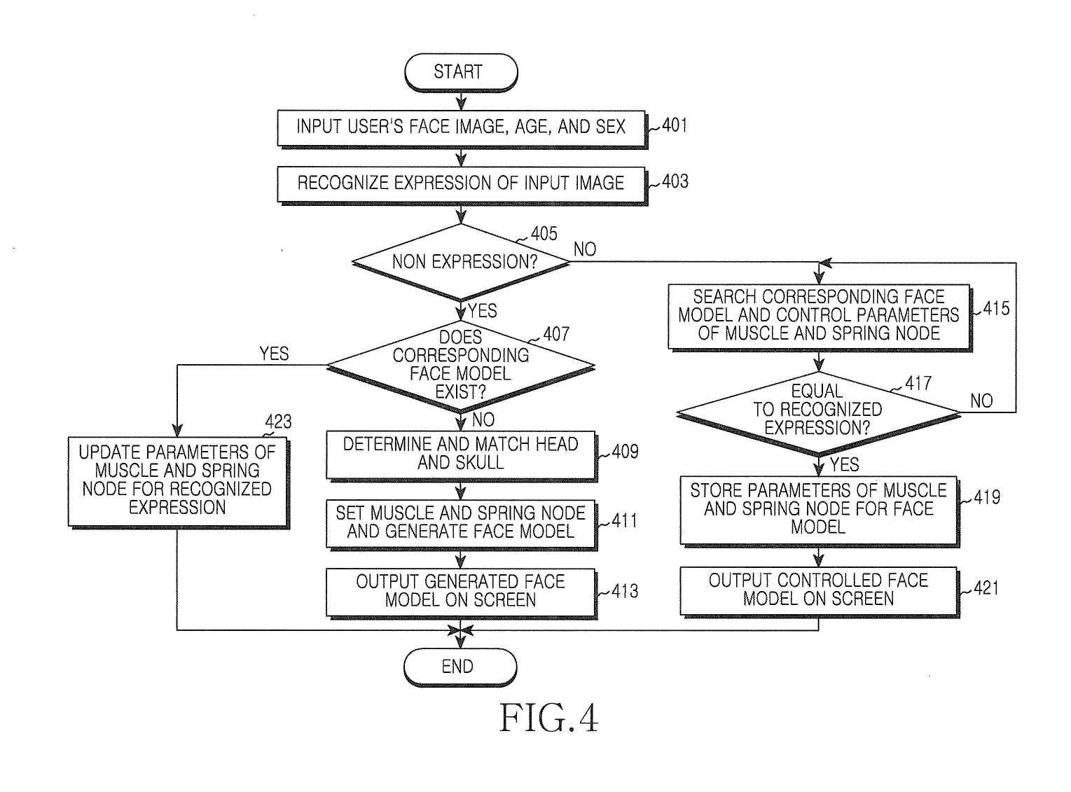

FIG. 4 illustrates a process for generating a face model and generating an animation of the face model in a computer system according to an embodiment of the present invention.

Referring to FIG. 4, in step 401, the computer system receives an input of a user's face image, age, and sex, and then proceeds to step 403 and recognizes an expression of the input face image. According to an embodiment, the computer system may recognize the expression of the face image using an expression recognition algorithm.

In step 405, the computer system determines whether the expression of the face image is a non expression. When the expression of the face image is a non expression, the computer system proceeds to step 407 and determines whether a face model corresponding to the face image exists. That is, the computer system determines whether the face model with substantially the same feature as the face image has been previously stored.

If it is determined in step 407 that the face model corresponding to the face image does not exist, in order to generate a face model for a user, the computer system proceeds to step 409 and determines a head model and a skull and matches them with each other and then, in step 411, the computer system sets a muscle and spring node for the matched head model and generates the face model. That is, the computer system acquires a three-dimensional point model from the input user's face image, and then fits a standard head model to the three-dimensional point model. The computer system then analyzes a position relationship for facial features of the user's face image, selects a skull shape corresponding to the analyzed position relationship for the facial features among previously stored skull shapes, and matches the fitted standard head model with the skull shape. At this time, the computer system sets a skin thickness map according to the standard head model and the skull shape to generate a skin for the matched head model, and sets parameters of a muscle and spring node for the matched head model to generate a face model for the face image. According to an embodiment, the computer system may select the standard head model and the skull shape by considering at least one of the age and sex input in step 401, and may set an elasticity of the spring node using the age.

In step 413, the computer system outputs the generated face model on a screen and terminates the algorithm according to an embodiment of the present invention. At this time, the computer system may store the generated face model and the parameter values of the muscle and spring node for the face model.

In contrast, when it is determined in step 407 that the face model for the face image exists, the computer system proceeds to step 423 to acquire parameters of a muscle and spring node for the expression recognized in step 403 and update previously stored parameters of a muscle and spring node for the non expression. The computer system then terminates the algorithm according to an embodiment of the present invention.

If it is determined in step 405 that the expression of the face image is not a non expression, in step 415, the computer system searches a corresponding face model and controls parameters of a muscle and spring node for the searched face model. The computer system then proceeds to step 417 and determines whether an expression of the controlled face model is substantially equal to the recognized expression of the input face image. When it is determined in step 417 that the expression of the face model is not substantially the same as the expression of the input face image, the computer system returns to block 415 and again performs the subsequent steps (415 and 417). When it is determined in step 417 that the expression of the face model is equal to the expression of the input face image, the computer system proceeds to step 419 to map parameters of a muscle and spring node for the controlled face model with the recognized expression and store the mapping result.

In step 421, the computer system outputs the controlled face model on the screen and terminates the algorithm according to an embodiment of the present invention.

By changing an expression of a face model in accordance with an expression of an input face image and storing parameter values of a muscle and spring node indicating the changed expression of the face model in according to an embodiment, the computer system controls parameters of a muscle and spring node for the face model based on the stored parameters of the muscles and spring nodes for the respective expressions, thus being capable of generating face models with expressions not previously input to the computer system.

As described above, embodiments of the present invention have an effect of, by automatically estimating parameters for a face model and generating an anatomic facial animation, being capable of allowing a user to easily generate a face model and generate a facial animation with various expressions without manually adjusting various parameters in a computer system. Furthermore, the embodiments of the present invention have an effect of being capable of obtaining a face model of high reality by considering phenomena of knotting of a skin tissue on wrinkling or contraction according to user's age and sex.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for generating a facial animation in a computer system, the method comprising:
receiving an input of a face image;
determining a head model and a skull model for the face image;
matching the head model with the skull model and generating a face model; and
adjusting at least one parameter for the generated face model according to an expression of the input face image.

2. The method of claim 1, wherein determining the head model for the face image comprises:
acquiring a model of a three-dimensional point form from at least two face images; and
fitting a previously stored standard head model to the model of the three-dimensional point form.

3. The method of claim 1, wherein determining the skull model for the face image comprises:
analyzing a position relationship for facial features of a face; and
determining the skull model that corresponds to the analyzed position relationship among previously stored skull models.

4. The method of claim 1, wherein matching the head model with the skull model and generating the face model comprises:
setting a skin thickness map corresponding to the head model and the skull model; and
generating a skin of the generated face model according to the set skin thickness map.

5. The method of claim 1, wherein matching the head model with the skull model and generating the face model comprises:
setting a parameter of a muscle for the generated face model; and
setting a parameter of a spring node of a mesh structure for the generated face model.

6. The method of claim 4, further comprising:
receiving an input of age; and
setting an elasticity of the skin based on the age.

7. The method of claim 5, further comprising:
receiving an input of sex; and
determining at least one of the head model, the skull model, and the mesh structure based on the sex.

8. The method of claim 5, wherein adjusting the at least one parameter for the generated face model comprises:
adjusting at least one of the muscle parameter and the spring node parameter for the generated face model;
comparing an expression of the parameter-adjusted face model with the expression of the input face image; and
repeatedly adjusting at least one of the muscle parameter and the spring node parameter until the expression of the adjusted face model is substantially equal to the expression of the input face image.

9. The method of claim 8, further comprising storing, as a parameter for a corresponding expression of the face model, at least one of the repeatedly adjusted muscle parameter and spring node parameter.

10. The method of claim 9, further comprising generating an expression of the face model corresponding to an expression not input, using at least one parameter stored for each expression.

11. An apparatus for generating a facial animation in a computer system, the apparatus comprising:
a user interface configured to receive an input of a face image;
a face model set unit configured to determine a head model and a skull model for the face image, and match the head model with the skull model, and generate a face model; and
a face model adjustment unit configured to adjust at least one parameter for the generated face model according to an expression of the input face image.

12. The apparatus of claim 11, wherein the face model set unit is further configured to acquire a model of a three-dimensional point form from at least two face images, and fit a previously stored standard head model to the model of the three-dimensional point form.

13. The apparatus of claim 11, wherein the face model set unit is further configured to analyze a position relationship for facial features of a face, and determine the skull model that corresponds to the analyzed position relationship among previously stored skull models.

14. The apparatus of claim 11, wherein the face model set unit is further configured to set a skin thickness map corresponding to the head model and the skull model, and generate a skin of the generated face model according to the set skin thickness map.

15. The apparatus of claim 11, wherein the face model set unit is further configured to set a parameter of a muscle for the generated face model, and set a parameter of a spring node of a mesh structure for the generated face model.

16. The apparatus of claim 14, wherein the user interface is further configured to receive an input of age, and
wherein the face model set unit is further configured to set an elasticity of the skin based on the age.

17. The apparatus of claim 15, wherein the user interface is further configured to receive an input of sex, and
wherein the face model set unit is further configured to determine at least one of the head model, the skull model, and the mesh structure based on the sex.

18. The apparatus of claim 15, wherein the face model adjustment unit is further configured to adjust at least one of the muscle parameter and the spring node parameter for the generated face model, compare an expression of the parameter-adjusted face model with the expression of the input face image, and repeatedly adjust at least one of the muscle parameter and the spring node parameter until the expression of the adjusted face model is substantially equal to the expression of the input face image.

19. The apparatus of claim 18, wherein the face model set unit is further configured to store, as a parameter for a corresponding expression of the face model, at least one of the muscle parameter and spring node parameter repeatedly adjusted in the face model adjustment unit.

20. The apparatus of claim 19, further comprising an expression synthesis unit configured to generate an expression of the face model corresponding to an expression not input, using at least one parameter for each expression stored in the face model set unit.
